(19) United States
(12) Patent Application Publication
(10) Pub. No.: US 2015/0224364 A1
(43) Pub. Date: Aug. 13, 2015

(54) Exercise Device with Portable Remote Control

(71) Applicant: Jackson Bishop Hsieh, Arcadia, CA (US)

(72) Inventor: Jackson Bishop Hsieh, Arcadia, CA (US)

(21) Appl. No.: 14/176,129

(22) Filed: Feb. 9, 2014

(51) Int. Cl. A63B 24/00; H04L 29/08; G05B 15/02

(52) U.S. Cl. CPC A63B 24/0087; G05B 15/02; H04L 67/10

(57) ABSTRACT

An exercise system for integrating exercise related information of a user from an exercise device, includes a portable remote control and a server. The portable remote control provides a control channel for receiving the exercise related information from a control module of the exercise device via a wireless link. The portable remote control further includes a user interface being customized for enabling the user to directly control an operation of the exercise device through the user interface. The server is linked to the portable remote control for receiving the exercise related information from the portable remote control when the workout is completed, wherein the server is arranged for storing and analyzing the exercise related information so as to minimize the exercised related information to be accumulatively stored in the portable remote control.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to an exercise device, and more particularly to an exercise device with a portable remote control which is capable of fully controlling the exercise device by a user, and fully customizing the user interface of the portable remote control and exercising program of the exercise device according to the personal information of the user.

2. Description of Related Arts

A conventional exercise device, such as a treadmill, usually comprises a running platform and a control station permanently installed in front of the running platform for allowing a user to control the operation of the running platform. Conventionally, the control station allows the user to control the running parameters, such as speed and time, for a specific exercise period. Moreover, the control station also allows the user to switch on or off the treadmill. There exist several disadvantages in association with this type of conventional exercise device.

First, conventional exercise devices do not normally record user's health conditions for analysis purpose. The exercise device may monitor user's heartbeat for the purpose of stopping the corresponding exercise when emergency in user's health exists.

However, in terms of comprehensively analyzing the user's health conditions, conventional exercise devices fail to accompany this function. As a result, many users need to hire a personal trainer to manage and monitor their health conditions.

Second, conventional exercise devices are not equipped to monitor user's health conditions. The users have to rely on other devices to check their health conditions. For example, the user has to get individual devices for checking different health data, such as blood pressure, weight, heartbeat etc. More importantly, these devices are not in any way linked to the exercise device so that the figures are related to the exercise session. In other words, there is not any system which monitors the health conditions of the user before and after exercising.

Third, conventional exercise devices do not provide a comprehensive record as to the health conditions of the user with respect to the exercise sessions. Thus, the user has no way to review his or her overall exercise effect. He or she has to either manually record the figures or hire the personal trainer to do it. However, the latter usually involve a considerable sum of money which not everyone is able to afford.

An advanced exercising system can interactive with the user via a mobile device. In particular, the exercise device can be linked to the mobile device of the user such that exercise-related information can be transmitted from the exercise device to the mobile device. The user is able to download a corresponding application in the mobile device to store and analyze the exercise-related information. However, the storage space of the mobile device is limited so that the storage space of the mobile device will be eventually full when the exercise-related information is accumulatively saved in the mobile device. Furthermore, the microprocessor of the mobile device must be powerful enough to analyze the exercise-related information. In other words, the battery life of the mobile device will be shortened in order to execute the analysis of the exercise-related information.

Therefore, the advanced exercising system further incorporates with a network server to directly store, update, and analyze the exercise-related information from the exercise device, wherein the mobile phone can only access the network server to view the exercise-related information therein. In other words, there is no communication between the exercise device and the mobile phone. After analyzing the exercise-related information, the network server can automatically program and control the exercise to device corresponding to the exercise-related information. For example, when the heart rate of the user is detected above a threshold calculated corresponding to the exercise-related information, the network server will send a deactivating signal to the exercise device to turn off the exercise device. Therefore, the network server will automatically control the exercise device to prevent the user being over-exercising. However, it is dangerous to stop the exercise device suddenly when the user is exercising. In fact, the exercise device must be only controlled by the user because only the user understands his or her own healthy habits and efforts.

Examples of the advanced exercising system are shown as follows.

U.S. Pat. No. 8,277,377 disclosed a method and apparatus for monitoring exercise with wireless interne connectivity, wherein a web-based wireless phone is coupled to an exercise device, such that an application downloaded in the wireless phone will receive data, such as heart rate, from a user during exercising. However, the battery life of the wireless phone will be drained rapidly because the wireless phone must continuously receive and analyze the data during exercising. For example, the user may run on the treadmill for one hour so that the data within the hour will be continuously sent to and analyzed by the wireless phone. Also, the storage space of the wireless phone will be eventually full when the data is accumulatively saved in the wireless phone.

U.S. Pat. No. 6,702,719 disclosed an exercise machine which is controlled according to exercise-related data for a user from an independent computing device. As it is mentioned above, the exercise machine should not be controlled by any computing device but the user.

U.S. Pat. No. 7,789,800 disclosed an exercise system, wherein a memory is configured to store physical activity related information regarding the user of the portable physical activity sensing system and a processor is configured to analyze and update information received from the portable physical activity sensing system. The major drawbacks are that the storage space of the memory will be eventually full when the data is accumulatively saved in the memory and the processor must be powerful enough to analyze the information.

U.S. Pat. No. 7,454,002 disclosed a method for integrating personal data, wherein, during exercising, the personal data is periodically transmitted from a wireless communication device to a network server which analyzes the personal data, posts a feedback, and compares personal data between the user and other different user. In other words, the network server will analyze the personal data in a real time manner during exercising. Therefore, the network server must be powerful enough to analyze different users concurrently when they are exercising at the same time.

U.S. Pat. No. 8,298,123 disclosed a local exercise system which comprises a local computer configured to control an operation of an exercise apparatus based upon a script stored in a rear/write memory of the local computer, wherein the script have been received over a wide area network interface from a remote server system. Accordingly, the exercise apparatus should not be controlled by any computing device but the user.

U.S. Pat. No. 7,030,735 disclosed a wireless motion monitoring device for controlling an exercise equipment, which comprises a motion signal receiving module plugged into a connection port of the exercise equipment and a wireless motion signal detecting module having a sensor for detecting a motion signal of the user and transmitting the motion signal. Accordingly, the exercise equipment must provide the connection port in order to connect the motion signal receiving module with the wireless motion signal detecting module. Also, the exercise equipment should not be controlled by the wireless motion signal detecting module but the user.

U.S. Pat. No. 6,936,007 disclosed an internet-enabled wireless web device which comprises a port for communications with an implantable medical device to accept a health parameter from the implantable medical device. Therefore, there is only one single communication between the wireless web device and the implantable medical device.

U.S. Pat. No. 6,602,191 disclosed an internet-enabled wireless web device which comprises a web-enable cellular phone having a first communication port including a generic input/output port for receipt of a health parameter, the health parameter corresponding to a patient's disease state or condition, or to a patient's health, nutrition fitness or exercise state or condition. In other words, the health parameter of the user will only be stored in the cellular phone and will be analyzed by the cellular phone to take up the storage space thereof.

U.S. Pat. No. 8,388,500 disclosed a tangible computer-readable storage medium, wherein exercise information is received during the workout via a portable wireless communication device, and the fitness information is updated during the workout to be stored on the fitness analysis system which also analyzes the updated fitness information as well. Likewise, the portable wireless communication device must keep receiving exercise information during the workout and the fitness analysis system must keep analyzing the exercise information in real time manner.

U.S. Pat. No. 8,235,871 disclosed a fitness analysis system for receiving fitness information of a user during the workout, storing and updating the fitness information, and analyzing the updated fitness information. Accordingly, the fitness analysis system must be powerful enough to simultaneously receive, update, and analyze the fitness information in real time manner for different users when they are exercising at the same time.

U.S. Pat. No. 7,811,201 disclosed a method and wireless device for use in connection with a fitness program and exercise apparatus. However, the fitness information will be updated and only be stored in the portable wireless communication device during the workout. The result will be calculated by the portable wireless communication device. In addition, the exercise apparatus cannot be controlled by the portable wireless communication device. In other words, the portable wireless communication device must be powerful enough to update, calculate, and store the fitness information all in one single device.

### SUMMARY OF THE PRESENT INVENTION

The invention is advantageous in that it provides a method and system for integrating exercise related information of a user, which simplifies the configuration among the exercise device, the portable remote control, and the server, so as to enhance the mutual efficiency of each of the exercise device, the portable remote control, and the server.

Another advantage of the invention is to a method and system for integrating exercise related information, wherein the exercise related information is sent from the portable remote control to the server only when the workout is completed. Therefore, there is no interruption for the user during exercising.

Another advantage of the invention is to a method and system for integrating exercise related information, wherein the exercise related information will be stored in a server instead of the portable remote control so as to minimize the storage usage of the portable remote control.

Another advantage of the invention is to a method and system for integrating exercise related information, wherein the exercise related information is analyzed only in the server, such that no specific requirement, such as a powerful microprocessor, for the portable remote control to execute the analysis of the exercise related information. In addition, since there is no exercise related information being sent from the portable remote control to the server during exercising, the server will only inquire for analyzing the exercise related information once the workout is completed.

Another advantage of the invention is to a method and system for integrating exercise related information, wherein the portable remote control provides a user interface being customized for enabling the user to directly control an operation of the exercise device through the user interface. Therefore, the user interface can be customized by the user according to his or her own healthy habits in order to control the to exercise device. In other words, the exercise device is only controlled by human being but not other machine.

Another advantage of the invention is to a method and system for integrating exercise related information, wherein the portable remote control and the server form an exercise system for incorporating with any existing exercise device having a control module. Therefore, the present invention does not require to alter the original structural design of the exercise device, so as to minimize the manufacturing cost of the exercise device incorporating with the portable remote control and the server.

Another advantage of the invention is to a method and system for integrating exercise related information, wherein no expensive or complicated structure is required to employ in the present invention in order to achieve the above mentioned objects.

Therefore, the present invention successfully provides an economic and efficient solution for integrating the exercise related information to the portable remote control and for analyzing the exercise related information by the server.

Additional advantages and features of the invention will become apparent from the description which follows, and may be realized by means of the instrumentalities and combinations particular point out in the appended claims.

According to the present invention, the foregoing and other objects and advantages are attained by a method for integrating exercise related information of a user from an exercise device to a portable remote control, comprising the steps of:

(a) creating a control channel between a control module of the exercise device and the portable remote control to receive the exercise related information from the exercise device to the portable remote control via a wireless link;

(b) sending the exercise related information by the portable remote control to a server only when the workout is completed; and

(c) storing and analyzing the exercise related information by the server.

In accordance with another aspect of the invention, the present invention comprises an exercise system for integrating exercise related information of a user from an exercise device, comprising:

a portable remote control which provides a control channel for receiving the exercise related information from a control module of the exercise device via a wireless link; and

a server linked to the portable remote control via Internet for receiving the exercise related information from the portable remote control only when the workout is completed, wherein the server is arranged for storing and analyzing the exercise related information so as to minimize the exercised related information to be accumulatively stored in the portable remote control.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a block diagram illustrating an exercise system according to a preferred embodiment of the present invention.

FIG. 2 is a flow chart illustrating a method for integrating exercise related information according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

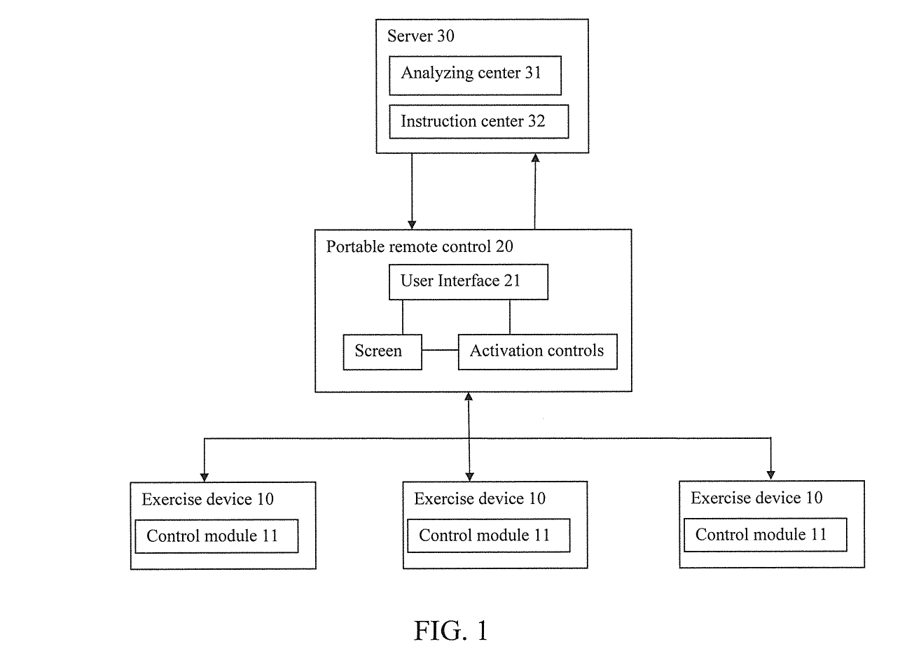

Referring to FIG. 1 of the drawings, an exercise system for integrating exercise related information of a user from an exercise device 10 according to a preferred embodiment is illustrated, wherein the exercise system comprises a portable remote control 20 and a server 30.

The exercise device 10 can be treadmill, a stepper, an exercise cycle, an elliptical machine, or a rowing for the user to workout. The exercise device 10 comprises a control module 11 arranged to control an operation of the exercise device 10, such as the running parameters including as speed and time for a specific exercise period, and collect the exercise related information, such as heart rate, exercise time, exercise distance, burned calories, and the like, during exercising.

According to the preferred embodiment, the portable remote control 20 is arranged to communicatively link to control module 11 of the exercise device 10. In particularly, the portable remote control 20 provides a control channel for receiving the exercise related information from the control module 11 of the exercise device 10 via a wireless link. The control channel is established via the wireless link, such as “Bluetooth” connectivity, Infrared connectivity, WiFi connectivity, or RF connectivity. It is worth mentioning that the portable remote control 20 is activated for receiving the exercise related information from the exercise device 10 during exercising. In other words, no data transmission between the portable remote control 20 and the server 30 during exercising.

Preferably, once the portable remote control 20 is linked to the exercise device 10, the portable remote control 20 is activated between an operation mode when the user is exercising, and a transmitting mode for sending out the exercise related information to the server 30 when the workout is completed. Therefore, once the user finish the workout, the portable remote control 20 will be activated from the operation mode to the transmitting mode to send the exercise related information to the server 30.

Accordingly, the portable remote control 20 can be configured to have an application adapted to be downloaded to any Internet-enable mobile device, such as mobile phone or tablet. Therefore, using the application in the mobile device, the exercise related information will be sent to the mobile device from the exercise device 10. It is worth mentioning that when executing the application, the portable remote control 20 will be automatically linked to the exercise device 10 and will identify what kind of exercise device 10 the user operating. For example, the portable remote control 20 will identify the treadmill when connecting to the control module 11 of the treadmill. Therefore, the exercise related information will be sent from the treadmill to the portable remote control 20.

In particular, the portable remote control 20 further provides a user interface 21 for being customized by the user. Using the user interface 21, the user is able to directly control an operation of the exercise device 10. In other words, the user is able to control the operation of the exercise device 10 at the operation mode.

For example, the user is able to customize the user interface 21 when the portable remote control 20 is linked to the treadmill. Therefore, parameters of exercise time, exercise distance, and target burned calories can be customized in the user interface 21 to control the treadmill. The user is also able to control the running speed of the treadmill via the user interface 21, wherein the user is able to slow down the running speed of the treadmill through the user interface 21. In other words, the exercise device 10 will only be controlled by the user via the user interface 21.

Accordingly, the exercise related information will also be displayed on a screen of the portable remote control 20. For example, for the treadmill or the elliptical machine, the exercise related information, such as the exercise level, elapsed time, calories, speed (MPH), distance (MILE), and pulse (BPM), will be displayed on the screen of the portable remote control 20. Therefore, the user is able to view the exercise related information during exercising. Furthermore, a plurality of activation controls, such as “pause” and “stop” controls, are provided by the portable remote control 20, such that the user is able to actuate the activation controls to control the operation of the exercise machine 10. Preferably, the screen of the portable remote control 20 is a touch screen, wherein the activation controls are provided on the screen for the user to control by means of a touch. For example, when the application of the portable remote control 20 is installed into a tablet, the exercise related information and the activation controls will be provided on the touch screen of the tablet.

When the parameters are set by the user via the user interface 21, the parameters is preset in the portable remote control 20 to determine whether the workout is completed or not. For example, when the workout time is set, the exercise related information will be automatically sent from the portable remote control 20 to the server 30 once the workout time is up.

According to the preferred embodiment, the server 30 is linked to the portable remote control 20 via Internet for receiving the exercise related information from the portable remote control 20 once the workout is completed. Accordingly, the exercise related information can be manually sent to the server 30 via one of the activation controls of the portable remote control 20 or can be automatically sent to the server 30 by the detection of the portable remote control 20. The server 30 is arranged for storing and analyzing the exercise related information so as to minimize the exercised related information to be accumulatively stored in the portable remote control 20. Accordingly, the portable remote control 20 can be wirelessly linked to the server 30 through “WiFi” connectivity or mobile communication network. Preferably, the server 30 can be a web-based platform that the user is able to use the portable remote control 20 to access the server 30 by any Internet browser.

The server 30 can be a network server or a “cloud” server linked to the portable remote control 20. Before the connection between the portable remote control 20 and the server 30, the user must register to the server 30 to be a member thereof, so as to create a personal account in the server 30. Therefore, a username and/or password will be given by the server to the portable remote control 20. In addition, the user is able to input the personal information, such as age, gender, and weight, in the personal account in order to analyze the exercise related information by the server 30.

Once the portable remote control 20 is linked to the server 30, the exercise related information will be sent to the server 30 when the workout is completed. In other words, there is no data transmission between the portable remote control 20 and the server 30 during exercising.

In particular, the exercise related information must be sent by the portable remote control 20 to the server 30, such that there is no direct communication between the exercise device 10 and the server 30. In addition, the exercise related information is sent to and stored in the server 30 through the portable remote control 20, such that the exercise related information is not stored in the portable remote control 20. In other words, the exercise related information will not take up any storage space of the portable remote control 20. When the user wants to retrieve the exercise related information, the user is able to utilize the portable remote control 20 to link to the server 30.

The server 30 comprises an analyzing center 31 generating an analyzed report to the portable remote control 20 after analyzing the exercise related information, and an instruction center 32 generating a suggested advise to portable remote control 20 regarding the analyzed report for enabling the user to select corrected exercise program for the exercise device 10.

Accordingly, the server 30 will generate the analyzed report regarding the exercise related information sent by the portable remote control 20. The user is able to view the analyzed report by the portable remote control 20. In other words, the calculation and analysis of the exercise related information will be performed by the analyzing center 31 of the server 30 but not by the portable remote control 20. Accordingly, the analyzed report will measure the strength and weakness of the user with fitness assessments. Therefore, the analyzed report will show the before and after workout and/or compare the current analyzed report with the previous analyzed report(s) to measure the improvement of the physical fitness of the user.

The suggested recommendation is generated by the instruction center 32 in response to the personal information input by the user and the analyzed report accumulatively recorded in the server 30. In the personal information, the user is able to set as a beginner, such that the suggested recommendation will generated to guide the user to use the exercise device 10, such as type of exercise, duration of exercise, and frequency of exercise, so as to prevent the user being over-exercising. The suggested recommendation will also include exercise prescription and instruction, such that the user is able to read the exercise prescription and instruction before using the exercise device 10 to exercise.

After a predetermined training period, different analyzed reports will be generated. The instruction center 32 will generate the suggest advise to increase the training time and/or running speed, as an example, in order to effectively guide the user to select corrected exercise program for the exercise device 10. Therefore, the instruction center 32 serves as a personal trainer for the user to motivate the user.

When the user inputs a target goal as one of the personal information in the personal account, the instruction center 32 will generate the suggested recommendation for the user. Therefore, the user is able to select the corrected exercise program for the particular exercise device 10 in order to achieve the target goal. For example, when the user input the target goal of “losing 5 lb in a month”, the instruction center 32 will automatically generate the suggested recommendation to guide the user to run the treadmill at a predetermined speed for 1 hour every other day once the treadmill is detected as the exercise device 10 by the portable remote control 20. Therefore, the user can follow the suggested recommendation to effectively achieve the target goal. The suggested advise will also include different aspects of wellness besides exercise, such as nutrition guidelines, such that the user is able to understand the his or her health in all aspects. It is worth mentioning that the user is able to access the server 30 by the portable remote control 20 and/or by a personal computer. Therefore, the user is able to read the analyzed report and/or the suggested recommendation in detail at any spare time.

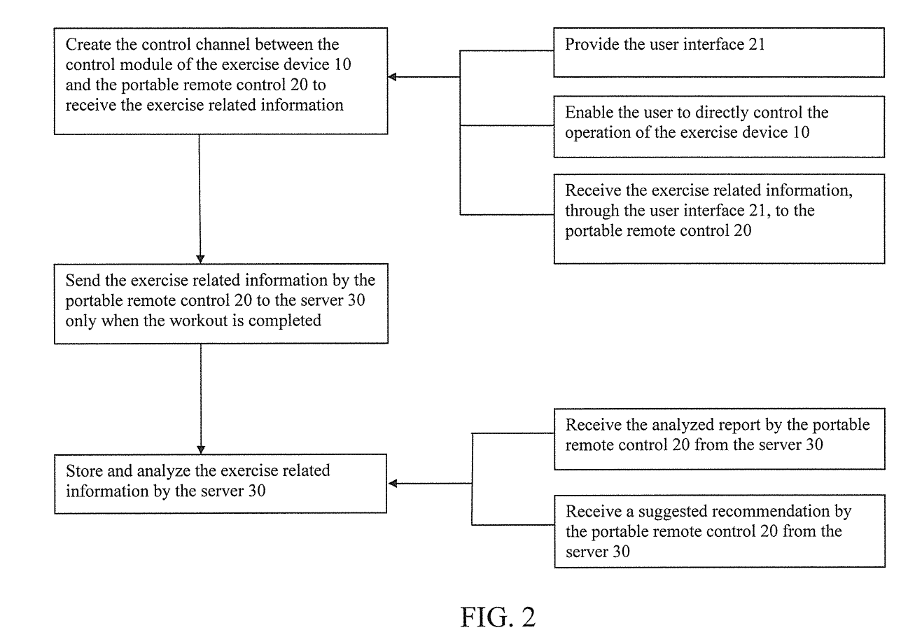

As shown in FIG. 2, the present invention further provides a method for integrating exercise related information of the user from the exercise device 10, which comprises the following steps.

(1) Create the control channel between the control module of the exercise device 10 and the portable remote control 20 to receive the exercise related information from the exercise device 10 to the portable remote control 20 via the wireless link. Accordingly, the user is able to download the application of the portable remote control 20 in the mobile phone or the tablet in order to create the control channel to the exercise device 10.

In the step (1), the portable remote control 20 further provides the following steps.

(1.1) Provide the user interface 21 of the portable remote control 20 being customized by the user to link to the control module of the exercise device 10 through the control link.

(1.2) Enable the user to directly control the operation of the exercise device 10 through the user interface 21. Accordingly, the portable remote control 20 is in an operation mode when the user is exercising. Therefore, the user can control the exercise device 10 at the operation mode. In other words, at the operation mode, the exercise related information will not be sent to the server 30 from the portable remote control 20.

(1.3) Automatically receive the exercise related information, through the user interface 21, to the portable remote control 20 during exercising. In other words, the user interface 21 of the portable remote control 20 can be synchronized with the exercise device 10 to collect the exercise related information. Alternatively, the user is able to manually operate the user interface 21 to receive the exercise information from the exercise device 10 to the portable remote control 20 without synchronizing the portable remote control 20 with the exercise device 10.

(2) Send the exercise related information by the portable remote control 20 to the server 30 once the workout is completed. After the workout is completed, the portable remote control 20 will transitionally received the exercise related information and will send the exercise related information to the server 30. Through the portable remote control 20, the exercise related information will be securely transmitted to the server 30 without directly transmitting to the server 30 from the exercise device 10.

(3) Store and analyze the exercise related information by the server 30. After the exercise related information is sent to the server 30, the user is optionally keep or delete the exercise related information in the portable remote control 20. Preferably, the exercise related information will be automatically removed from the portable remote control 20 since the exercise related information will be securely stored in the server 30. In particular, the step (3) further comprises the following steps.

(3.1) Receive the analyzed report by the portable remote control 20 from the server 30. Once the analyzed report is generated by the analyzing center 31, the analyzed report will sent to the portable remote control 20.

(3.2) Receive a suggested recommendation by the portable remote control 20 from the server 30 regarding the analyzed report, such that the user is able to select corrected exercise program for the exercise device.

It is worth mentioning that the exercise system of the present invention will enhance the efficiency of each of the exercise device 10, the portable remote control 20, and the server 30, wherein each of them will effectively get its own job done individually. In other words, the exercise device 10 will only obtain the exercise related information to collect the information of before and after workout, such that the portable remote control 20 will not require collecting the exercise related information from the exercise device 10 in a real time manner. During exercising, the exercise related information will transitionally send to the portable remote control 20. Therefore, the portable remote control 20 will not require large storage space to store the exercise related information. Furthermore, the user is able to carry the portable remote control 20 in order to operate different exercise devices 10 in any sequent order. The portable remote control 20 will receive different exercise related information from different exercise devices 10. Then, the portable remote control 20 will send the exercise related information to the server 30 after exercising for analyzing, wherein the analyzed report will be generated in response to the exercise related information from each and every exercise device 10. Therefore, the portable remote control 20 will not require powerful calculating power to analyze the exercise related information. It is worth mentioning that since there is no communication link between the exercise device 10 and the server 30, such that the exercise related information will not be directly sent from the exercise device 10 to the server 30. The exercise related information must be sent by the portable remote control 20, i.e. the personal belongings, so as to prevent any interception or leak of personal information between the exercise device 10 and the server 30. It is worth mentioning that multiple users can access the server 30 at the same time and the server 30 will analyze the exercise related information from different users at the same time.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method for integrating exercise related information of a user from an exercise device to a portable remote control, comprising the steps of:
(a) creating a control channel between a control module of said exercise device and said portable remote control to receive said exercise related information from said exercise device to said portable remote control via a wireless link;
(b) sending said exercise related information by said portable remote control to a server only when the workout is completed; and
(c) storing and analyzing said exercise related information by said server.

2. The method, as recited in claim 1, wherein said exercise related information is sent to and stored in said server through said portable remote control, such that said exercise related information is not stored in said portable remote control.

3. The method, as recited in claim 1, wherein said portable remote control comprises an application being downloaded into an Internet-enable mobile device to communicatively link to said server.

4. The method, as recited in claim 2, wherein said portable remote control comprises an application being downloaded into an Internet-enable mobile device to communicatively link to said server.

5. The method, as recited in claim 1, wherein the step (a) further comprises the steps of:
(a.1) providing a user interface of said portable remote control being customized by said user to link to said control module of said exercise device through said control link;
(a.2) enabling said user to directly control an operation of said exercise device through said user interface; and
(a.3) automatically receiving said exercise related information, through said user interface, to said portable remote control.

6. The method, as recited in claim 4, wherein the step (a) further comprises the steps of:
(a.1) providing a user interface of said portable remote control being customized by said user to link to said control module of said exercise device through said control link;
(a.2) enabling the user to directly control an operation of said exercise device through said user interface; and
(a.3) automatically receiving said exercise related information, through said user interface, to said portable remote control.

7. The method, as recited in claim 1, wherein the step (c) further comprises the steps of:
(c.1) receiving an analyzed report by said portable remote control from said server; and
(c.2) receiving a suggested recommendation by said portable remote control from said server regarding said analyzed report, such that said user is able to select corrected exercise program for said exercise device.

8. The method, as recited in claim 6, wherein the step (c) further comprises the steps of:
(c.1) receiving an analyzed report by said portable remote control from said server; and
(c.2) receiving a suggested recommendation by said portable remote control from said server regarding said analyzed report, such that said user is able to select corrected exercise program for said exercise device.

9. The method as recited in claim 1 wherein, in the step (a), said portable remote control is in an operation mode when said user is exercising, such that said portable remote control waits for sending said exercise related information to said server until the workout is completed.

10. The method as recited in claim 8 wherein, in the step (a), said portable remote control is in an operation mode when said user is exercising, such that said portable remote control waits for sending said exercise related information to said server until the workout is completed.

11. The method as recited in claim 1 wherein, in the step (b), said exercise related information must be sent by said portable remote control to said server, such that there is no direct communication between said exercise device and said server.

12. The method as recited in claim 10 wherein, in the step (b), said exercise related information must be sent by said portable remote control to said server, such that there is no direct communication between said exercise device and said server.

13. An exercise system for integrating exercise related information of a user from an exercise device, comprising:
a portable remote control which provides a control channel for receiving said exercise related information from a control module of said exercise device via a wireless link; and
a server linked to said portable remote control for receiving said exercise related information from said portable remote control only when the workout is completed, wherein said server is arranged for storing and analyzing said exercise related information so as to minimize said exercised related information to be accumulatively stored in said portable remote control.

14. The exercise system, as recited in claim 13, wherein said portable remote control is configured to have an application for being downloaded into an Internet-enable mobile device in order to communicatively link to said server.

15. The exercise system, as recited in claim 13, wherein said portable remote control comprises a user interface which is customable for linking to said control module of said exercise device and for enabling said user to directly control an operation of said exercise device through said user interface.

16. The exercise system, as recited in claim 14, wherein said portable remote control comprises a user interface which is customable for linking to said control module of said exercise device and for enabling said user to directly control an operation of said exercise device through said user interface.

17. The exercise system, as recited in claim 13, wherein said portable remote control is activated between an operation mode when said user is exercising, and a transmitting mode for sending said exercise related information to said serve when the workout is completed.

18. The exercise system, as recited in claim 16, wherein said portable remote control is activated between an operation mode when said user is exercising, and a transmitting mode for sending said exercise related information to said serve when the workout is completed.

19. The exercise system, as recited in claim 13, wherein said server comprises an analyzing center generating an analyzed report to said portable remote control after analyzing said exercise related information, and an instruction center generating a suggested recommendation to portable remote control regarding said analyzed report for enabling said user to select corrected exercise program for said exercise device.

20. The exercise system, as recited in claim 18, wherein said server comprises an analyzing center generating an analyzed report to said portable remote control after analyzing said exercise related information, and an instruction center generating a suggested recommendation to portable remote control regarding said analyzed report for enabling said user to select corrected exercise program for said exercise device.
